(19) United States
(12) Patent Application Publication
(10) Pub. No.: US 2017/0255407 A1
(43) Pub. Date: Sep. 7, 2017

(54) DEVICE, SAVE DATA REDUCTION METHOD, AND COMPUTER-READABLE RECORDING MEDIUM

(71) Applicant: FUJITSU LIMITED, Kawasaki-shi (JP)

(72) Inventor: Masaaki Noro, Kawasaki (JP)

(73) Assignee: FUJITSU LIMITED, Kawasaki-shi (JP)

(21) Appl. No.: 15/414,158

(22) Filed: Jan. 24, 2017

(30) Foreign Application Priority Data
Mar. 4, 2016 (JP) 2016-042860

(51) Int. Cl. G06F 3/06; G06F 11/32; G06F 9/44

(52) U.S. Cl. CPC G06F 3/0619; G06F 3/065; G06F 3/067; G06F 9/4418; G06F 11/327

(57) ABSTRACT

A device includes a memory that stores save data used to execute an application on the device, and a processor that is coupled to the memory. The processor instructs termination of a resident application which is a periodically executed application when the device is to be transited to a hibernation state which indicates a standby state with storing the save data in the memory, and activates the resident application of which termination is instructed when resuming the device from the hibernation state.

### CROSS-REFERENCE TO RELATED APPLICATION

This application is based upon and claims the benefit of priority of the prior Japanese Patent Application No. 2016-042860, filed on Mar. 4, 2016, the entire contents of which are incorporated herein by reference.

### FIELD

The embodiments discussed herein are related to a smart device, a save data reduction method, and a save data reduction program.

### BACKGROUND

A smart device such as a smartphone and a smartwatch is configured so that a period of a standby state during which no processing is performed is longer than its operating time. For example, the smartwatch operates only in a limited time such that when the smartphone notifies the smartwatch of an event or when a user changes settings, and is in the standby state during the other period of time. FIG. 17 is a diagram for explaining an operation of a smartwatch.

As illustrated in FIG. 17, for example, when there is an event incoming mail from a smartphone 9 in a standby state of a Bluetooth (registered trademark: hereinafter, the same as above) Low Energy (BLE), a smartwatch 8 notifies the user of the event using vibration or LED, etc. The smartwatch 8 performs an operation such as forwarding of mail body based on a user operation, and then returns to the standby state.

Thus, in the smart device, because the period of the standby state is long, by reducing power consumption in the standby state, the operating time of a battery can be prolonged. Therefore, there is a technology of transitioning the state of the smart device to a hibernation state during the standby state. FIG. 18 is a diagram for explaining reduction of power consumption by hibernation.

As illustrated in FIG. 18, when the smart device is in an active state, the power consumption becomes high, but a period in the active state is short as compared with a period in the standby state. In FIG. 18, “Power in Standby state (Old)” represents the power consumption in the standby state without hibernation enabled, while “Power in Standby state (New)” represents the power consumption in the standby state with hibernation enabled.

However, in order to cause the state of the smart device to transition to the hibernation state, the data of a central processing unit (CPU) and a memory needs to be saved, and the saved data needs to be restored when the smart device enters the active state. FIG. 19 is a diagram for explaining the save and restoration of the data during the state transition.

As illustrated in FIG. 19, the smartwatch 8 performs the save processing of the data before transition from the active state to the hibernation state and performs the restoration processing of the data before resuming from the hibernation state. Therefore, in the hibernation state, it is important to speed up the save processing and the restoration processing of the data as much as possible.

One way to speed up the save processing and the restoration processing of the data is to reduce the amount of data to be saved. Therefore, in order to reduce the amount of data to be saved, there is a technology of forcing an application to close. FIG. 20 is a diagram for explaining Force close and Restart of an application.

As illustrated in FIG. 20, the smartwatch 8 forces close an application before saving the data, and restarts the forced close application after the data restoration. In this case, an application to be terminated needs to be selected. For example, there are some technologies to solve the problem: a technology for selecting an application to be terminated based on priorities of the application and a technology for selecting an application to be terminated based on use frequency of the application.

Patent Literature 1: Japanese Laid-open Patent Publication No. 2014-174710

Patent Literature 2: Japanese Laid-open Patent Publication No. 2012-048427

However, there is a problem that only selection of an application (app) to be terminated based on the priorities or the use frequency is insufficient for reducing the amount of data to be saved. The app executed by the smart device includes resident apps in addition to general apps. The resident apps are resident in memory and are periodically executed. If the resident apps are not terminated, the data in a memory area occupied by the resident apps becomes a target to be saved, and therefore reduction of the data amount to be saved becomes insufficient.

### SUMMARY

According to an aspect of an embodiment, a device includes a memory that stores save data used to execute an application on the device, and a processor that is coupled to the memory. The processor instructs termination of a resident application which is a periodically executed application when the device is to be transited to a hibernation state which indicates a standby state with storing the save data in the memory, and activates the resident application of which termination is instructed when resuming the device from the hibernation state.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a functional configuration of a smart device according to a first embodiment;

FIG. 2A is a diagram illustrating an example of an app state table;

FIG. 2B is a diagram illustrating an example of an app state table in which only needed classification information is registered;

FIG. 3 is a flowchart illustrating a flow of processing performed by an app management unit;

FIG. 4 is a flowchart illustrating a flow of processing performed by an app control unit;

FIG. 5 is a diagram illustrating a functional configuration of a smart device according to a second embodiment;

FIG. 6 is a flowchart illustrating a flow of processing performed by the app control unit;

FIG. 7 is a diagram illustrating a functional configuration of a smart device according to a third embodiment;

FIG. 8 is a diagram for explaining a display on a notification bar performed by a resident app;

FIG. 9 is a flowchart illustrating a flow of processing performed by the app control unit;

FIG. 10 is a diagram illustrating a functional configuration of a smart device according to a fourth embodiment;

FIG. 11 is a flowchart illustrating a flow of processing performed by a drawing unit;

FIG. 12 is a flowchart illustrating a flow of processing performed by the app management unit;

FIG. 13 is a diagram illustrating a functional configuration of a smart device according to a fifth embodiment;

FIG. 14 is a flowchart illustrating a flow of processing performed by a package analyzing unit;

FIG. 15 is a flowchart illustrating a flow of processing performed by the app management unit;

FIG. 16 is a diagram illustrating a hardware configuration of a computer executing save data reduction programs according to the first to the fifth embodiments;

FIG. 17 is a diagram for explaining an operation of a smartwatch;

FIG. 18 is a diagram for explaining the reduction of power consumption by hibernation;

FIG. 19 is a diagram for explaining the save and restoration of the data; and

FIG. 20 is a diagram for explaining the force close and restart of an application.

### DESCRIPTION OF EMBODIMENTS

Preferred embodiments of the present invention will be explained with reference to accompanying drawings. The following embodiments are not limited to the disclosed technology.

### [a] First Embodiment

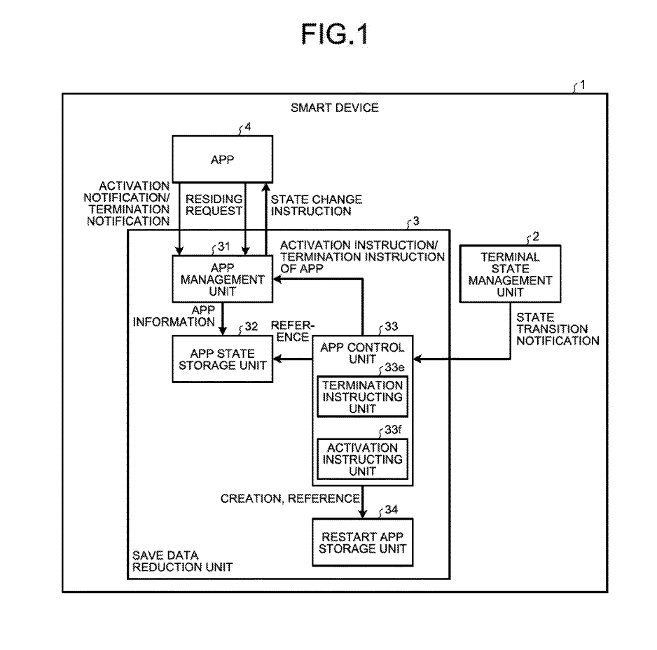

A functional configuration of a smart device according to a first embodiment will be explained first. FIG. 1 is a diagram illustrating a functional configuration of the smart device according to the first embodiment. As illustrated in FIG. 1, a smart device 1 includes a terminal state management unit 2, a save data reduction unit 3, and an app 4.

The terminal state management unit 2 manages states of the smart device 1. The state of the smart device 1 includes an active state and a hibernation state. When the state of the smart device 1 transitions to the other, the terminal state management unit 2 notifies the save data reduction unit 3 of the state transition.

The save data reduction unit 3 reduces the amount of save data by terminating the resident app operating on the smart device 1 when the smart device 1 transitions to the hibernation state. When the smart device 1 resumes from the hibernation state, the save data reduction unit 3 restarts the resident app terminated at the time of transition to the hibernation state.

The app 4 is an application executed by the smart device 1. FIG. 1 represents only one app 4 for the sake of simplicity, however, more apps 4 are executed in the smart device 1. The apps 4 include a resident app and a general app which is not resident in memory.

The terminal state management unit 2 and the save data reduction unit 3 are implemented by the smart device 1 executing the software. The app 4 operates in an app layer, and the terminal state management unit 2 and the save data reduction unit 3 operate in a middleware layer.

The save data reduction unit 3 includes an app management unit 31, an app state storage unit 32, an app control unit 33, and a restart app storage unit 34.

The app management unit 31 manages the states of the app 4. The app management unit 31 activates and terminates the app 4, switches between the foreground and the background, and performs, when the activated app is a resident app, procedures for being resident, and integrates entire application control. The foreground is a state in which a screen output by the app 4 is displayed on a display device, and the background is a state in which a screen output by the app 4 is not displayed on the display device. A residing request is a request to set the app 4 to a resident app.

The app management unit 31 restarts a resident app, terminates a background app, or the like when abnormality occurs. The app management unit 31 receives an activation notification, a termination notification, and a residing request from the app 4, and updates the app state storage unit 32.

When receiving an app activation instruction and an app termination instruction from the app control unit 33, the app management unit 31 gives a state change instruction to the app 4 so as to change the state based on the received instruction.

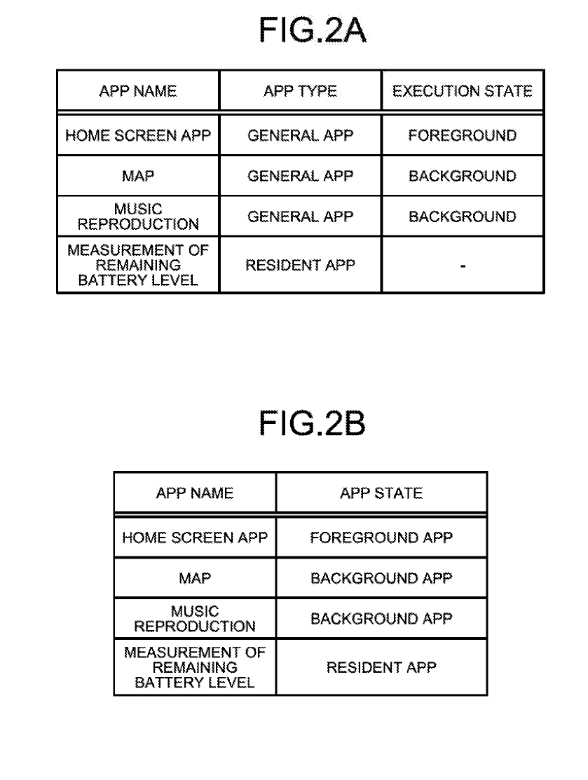

The app state storage unit 32 stores the states of the app 4 as an app state table. The app state table is updated by the app management unit 31. FIG. 2A is a diagram illustrating an example of the app state table. As illustrated in FIG. 2A, the app state table is information that associates App name, App type, and Execution state with each other.

“App name” indicates a name of the app 4. “App type” is a type of an app. The App type includes the general app and the resident app. “Execution state” indicates a state in which the app 4 is executed. The Execution state includes the foreground and the background. For example, a general app named as Home screen app is executed in the foreground.

The Execution state is provided only in the general apps but not in the resident app. Thus, only classification information needed to terminate the resident app at the time of transition to the hibernation state may be registered in the app state table without distinguishing between the general app and the resident app. FIG. 2B is a diagram illustrating an example of an app state table in which only needed classification information is registered.

As illustrated in FIG. 2B, the app state table is information that associates the App name with App state. “App state” indicates whether the app 4 is a foreground app or a background app, or the resident app. For example, the app 4 named as Home screen app is executed in the foreground.

The app control unit 33 controls the activation and termination of the app 4, and includes a termination instructing unit 33e that instructs the termination of the app 4 and an activation instructing unit 33f that instructs the activation of the app 4. When receiving a notification that the smart device 1 transitions to the hibernation state from the terminal state management unit 2, the termination instructing unit 33e refers to the app state table and instructs the app management unit 31 to terminate the resident app. At this time, the termination instructing unit 33e creates a list of terminated resident apps as a restart app list and stores the created list in the restart app storage unit 34.

When receiving a notification that the smart device 1 resumes from the hibernation state from the terminal state management unit 2, the activation instructing unit 33f refers to the restart app list and instructs the app management unit 31 to restart the resident app terminated by the termination instructing unit 33e. The restart app storage unit 34 stores the restart app list.

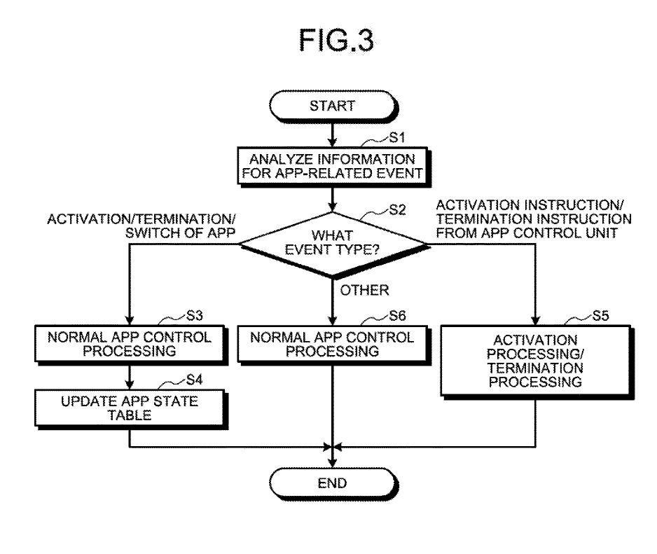

A flow of processing performed by the app management unit 31 will be explained next. FIG. 3 is a flowchart illustrating the flow of processing performed by the app management unit 31. As illustrated in FIG. 3, the app management unit 31 analyzes information for an app-related event (Step S1). The app-related event is a notification from the app 4, an instruction from the app control unit 33, and the like.

The app management unit 31 then determines what an event type is (Step S2). As a result, when the event type is activation, termination, or switch of the app 4 received from any device other than the app control unit 33, the app management unit 31 performs processing corresponding to the activation, the termination, or the switch of the app 4, that is, performs normal app control processing (Step S3). The app management unit 31 updates the app state table (Step S4).

When the event type is the activation instruction or the termination instruction of the app 4 received from the app control unit 33, because it is the activation or the termination of the app 4 related to the hibernation, the app management unit 31 performs the activation processing or the termination processing of the app 4 (Step S5). When the event type is the other one, the app management unit 31 performs processing corresponding to the event type, that is, performs normal app control processing (Step S6).

Thus, the app management unit 31 performs the activation processing or the termination processing of the app 4 based on the instruction from the app control unit 33, and can thereby perform the activation processing or the termination processing of the resident app related to the hibernation.

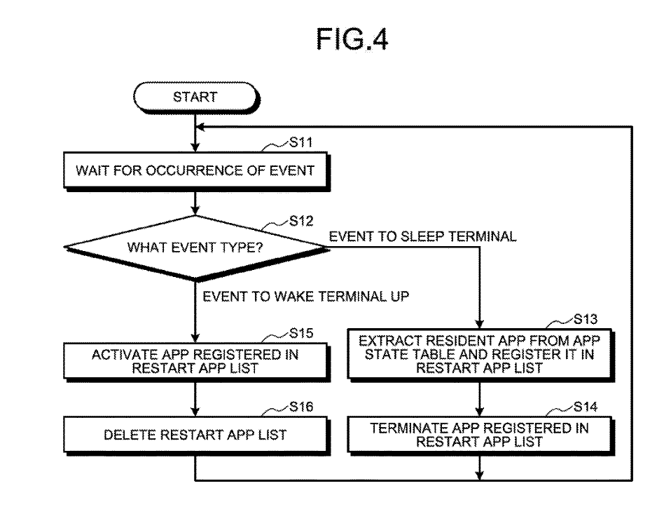

A flow of processing performed by the app control unit 33 will be explained next. FIG. 4 is a flowchart illustrating a flow of processing performed by the app control unit 33. As illustrated in FIG. 4, the app control unit 33 waits for occurrence of an event (Step S11). Herein, the event is a notification of state transition received from the terminal state management unit 2.

When an event occurs, the app control unit 33 then determines what an event type is (Step S12). As a result, when the event type is an event to cause the terminal to go to sleep, i.e., a transition to the hibernation state, the app control unit 33 extracts the resident app from the app state table and registers the extracted resident app in the restart app list (Step S13). Then, the app control unit 33 instructs the app management unit 31 to terminate the app 4 registered in the restart app list (Step S14), and returns to Step S11.

Meanwhile, when the event type is an event to wake the terminal up, i.e., to resume from the hibernation state, the app control unit 33 instructs the app management unit 31 to activate the app registered in the restart app list (Step S15). The app control unit 33 then deletes the restart app list (Step S16), and returns to Step S11.

Thus, the app control unit 33 instructs the app management unit 31 to terminate the resident app when transitioning to the hibernation state, and the smart device 1 can thereby reduce the amount of save data at the time of transition to the hibernation state.

As explained above, in the first embodiment, when the smart device 1 transitions to the hibernation state, the termination instructing unit 33e instructs the app management unit 31 to extract the resident app from the app state table and to terminate the resident app. When the smart device 1 resumes from the hibernation state, the activation instructing unit 33f instructs the app management unit 31 to activate the resident app of which termination is instructed by the termination instructing unit 33e. Therefore, the smart device 1 can reduce the amount of save data at the time of transition to the hibernation state.

### [b] Second Embodiment

Incidentally, in the first embodiment, although only the resident app is a target of the force close at the time of transition to the hibernation state, the background app can also be a target of the force close. Therefore, in the second embodiment, a smart device that also forces the background app to close at the time of transition to the hibernation will be explained below.

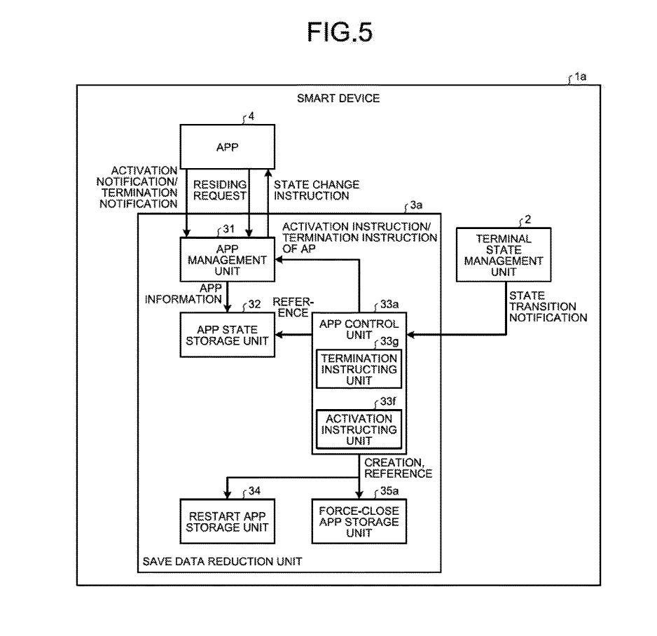

FIG. 5 is a diagram illustrating a functional configuration of a smart device according to the second embodiment. For the sake of simplicity of explanation, the same reference signs are assigned to function units that play the same roles as the units illustrated in FIG. 1, and detailed description thereof is omitted.

As illustrated in FIG. 5, a smart device 1a includes a save data reduction unit 3a instead of the save data reduction unit 3 as compared with the smart device 1 illustrated in FIG. 1. The save data reduction unit 3a includes an app control unit 33a instead of the app control unit 33, and includes a new force-close app storage unit 35a as compared with the save data reduction unit 3 illustrated in FIG. 1.

The force-close app storage unit 35a stores the app name of the background app to be forcibly closed as a force-close app list when the smart device 1a transitions to the hibernation state. The force-close app list is created by the app control unit 33a when the restart app list is created.

The app control unit 33a includes a termination instructing unit 33g instead of the termination instructing unit 33e as compared with the app control unit 33 illustrated in FIG. 1. The termination instructing unit 33g creates the restart app list and the force-close app list by referring to the app state table when the smart device 1a transitions to the hibernation state, and instructs the app management unit 31 to terminate the apps registered in the restart app list and the force-close app list.

The background app registered in the force-close app list is not restarted when the smart device 1a resumes from the hibernation state. The termination instructing unit 33g may register any background app whose memory usage is more than a given amount or may register only a predetermined number of background apps in order from those whose memory usage is more, instead of registering all the background apps in the force-close app list. The termination instructing unit 33g can acquire the memory usage by inquiring the kernel of the device.

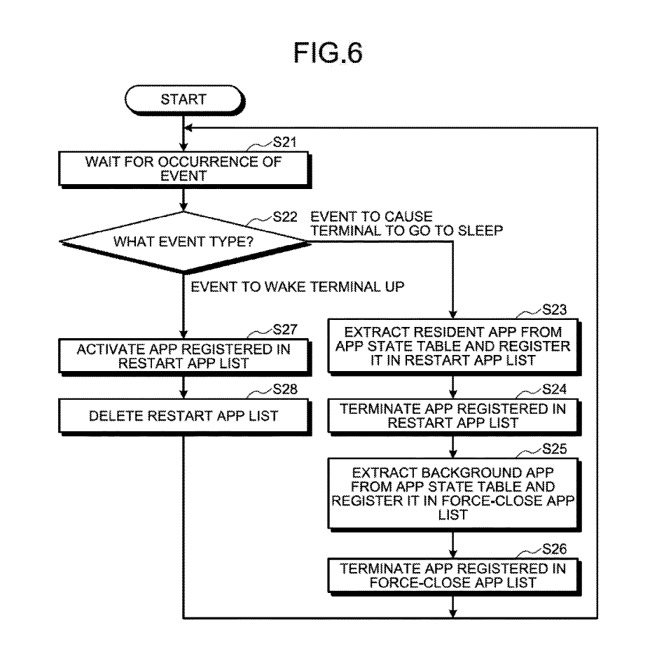

A flow of processing performed by the app control unit 33a will be explained next. FIG. 6 is a flowchart illustrating a flow of processing performed by the app control unit 33a. As illustrated in FIG. 6, the app control unit 33a waits for occurrence of an event (Step S21).

When an event occurs, the app control unit 33a determines what an event type is (Step S22). As a result, when the event type is an event to cause the terminal to go to sleep, i.e., a transition to the hibernation state, the app control unit 33a extracts the resident app from the app state table and registers the extracted resident app in the restart app list (Step S23). Then, the app control unit 33a instructs the app management unit 31 to terminate the app registered in the restart app list (Step S24).

The app control unit 33a extracts the background app from the app state table and registers the extracted app in the force-close app list (Step S25). The app control unit 33a then instructs the app management unit 31 to terminate the app registered in the force-close app list (Step S26), and returns to Step S21.

Meanwhile, when the event type is an event to wake the terminal up, i.e., to resume from the hibernation state, the app control unit 33a instructs the app management unit 31 to activate the app registered in the restart app list (Step S27). The app control unit 33a then deletes the restart app list (Step S28), and returns to Step S21.

As explained above, in the second embodiment, the app control unit 33a instructs the app management unit 31 to also terminate the background app at the time of transition to the hibernation state. Therefore, the smart device 1a can further reduce the amount of save data at the time of transition to the hibernation state.

### [c] Third Embodiment

There are apps 4 that perform a display on a notification bar, among the resident apps, such as an app 4 that displays a radio field strength and an app 4 that displays a remaining battery level. There are also the apps 4 that are more likely to be used when resuming from the hibernation state, such as an app 4 that displays a home screen and an app launcher among the background apps.

These apps 4 are desirably performed as soon as possible at the time of resuming from the hibernation state. If these apps 4 are not performed, there is missing part in the screen display. Therefore, in the third embodiment, a smart device that does not terminate these apps 4 at the time of transition to the hibernation state will be explained below.

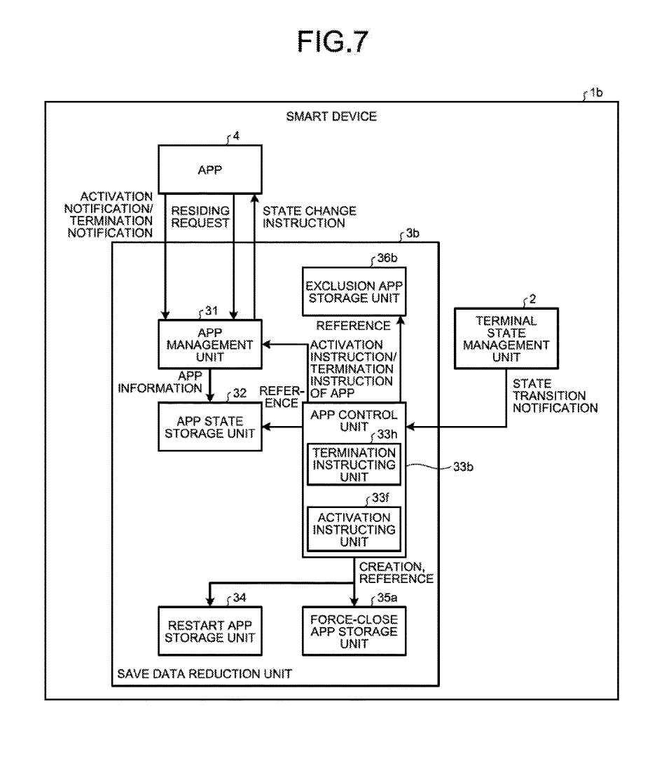

FIG. 7 is a diagram illustrating a functional configuration of a smart device according to the third embodiment. For the sake of simplicity of explanation, the same reference signs are assigned to function units that play the same roles as the units illustrated in FIG. 5, and detailed description thereof is omitted.

As illustrated in FIG. 7, a smart device 1b includes a save data reduction unit 3b instead of the save data reduction unit 3a as compared with the smart device 1a illustrated in FIG. 5. The save data reduction unit 3b includes an app control unit 33b instead of the app control unit 33a and includes a new exclusion app storage unit 36b as compared with the save data reduction unit 3a illustrated in FIG. 5.

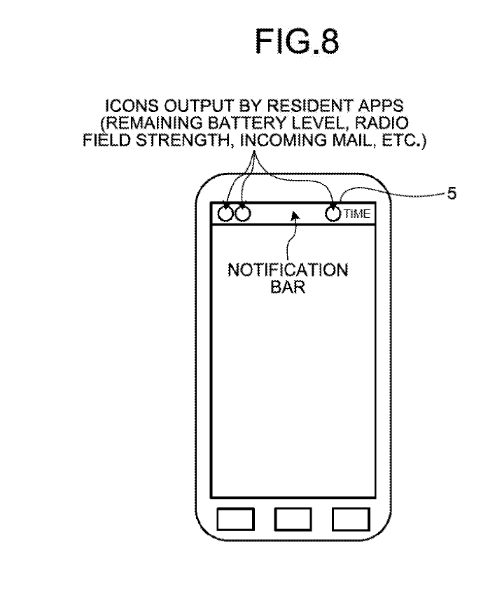

The exclusion app storage unit 36b stores a list of apps that are excluded from the apps 4 terminated at the time of transition to the hibernation state, as an exclusion app list. The exclusion app list includes a resident app that performs a display on the notification bar. FIG. 8 is a diagram for explaining a display on the notification bar performed by a resident app. As illustrated in FIG. 8, the apps that output a remaining battery level, a radio field strength, a time, and an incoming mail, etc., display icons on the notification bar 5.

The exclusion app list includes the background app that displays a regular screen, such as the app 4 that displays the home screen and the app launcher. The exclusion app list is created by the user.

The app control unit 33b includes a termination instructing unit 33h instead of the termination instructing unit 33g as compared with the app control unit 33a illustrated in FIG. 5. The termination instructing unit 33h has the same function as that of the termination instructing unit 33g, and instructs the app management unit 31 to terminate the apps 4 obtained by excluding the apps included in the exclusion app list from the apps registered in the restart app list and the force-close app list.

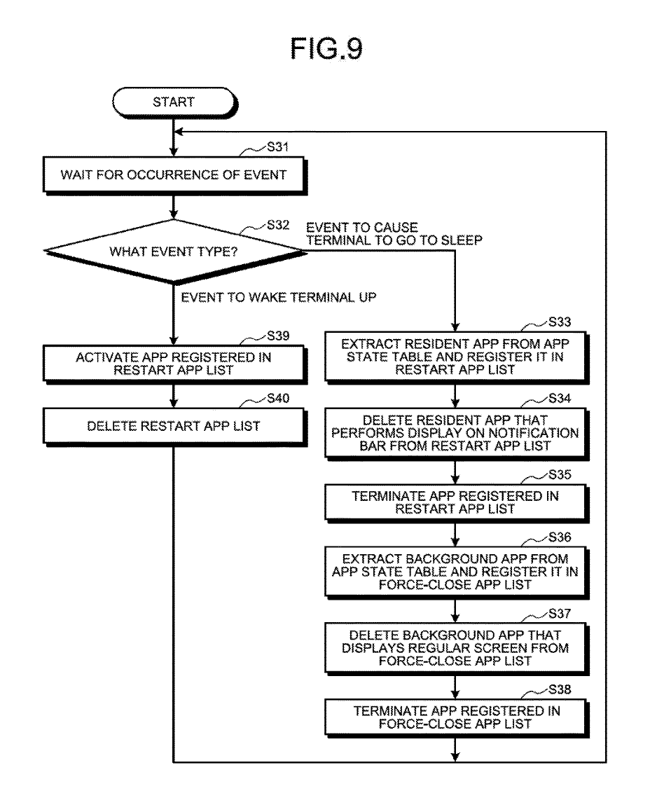

A flow of processing performed by the app control unit 33b will be explained next. FIG. 9 is a flowchart illustrating a flow of processing performed by the app control unit 33b. As illustrated in FIG. 9, the app control unit 33b waits for occurrence of an event (Step S31).

When an event occurs, the app control unit 33b determines what an event type is (Step S32). As a result, when the event type is an event to cause the terminal to go to sleep, i.e., a transition to the hibernation state, the app control unit 33b extracts the resident app from the app state table and registers the extracted resident app in the restart app list (Step S33). Then, the app control unit 33b refers to the exclusion app list to delete the resident app that performs a display on the notification bar 5 from the restart app list (Step S34), and instructs the app management unit 31 to terminate the app registered in the restart app list (Step S35).

The app control unit 33b extracts the background app from the app state table and registers the extracted app in the force-close app list (Step S36). The app control unit 33b refers to the exclusion app list to delete the background app that displays the regular screen from the force-close app list (Step S37). The app control unit 33b then instructs the app management unit 31 to terminate the app registered in the force-close app list (Step S38), and returns to Step S31.

Meanwhile, when the event type is an event to wake the terminal up, i.e., to resume from the hibernation state, the app control unit 33b instructs the app management unit 31 to activate the app registered in the restart app list (Step S39). The app control unit 33b then deletes the restart app list (Step S40), and returns to Step S31.

As explained above, in the third embodiment, the app control unit 33b excludes the apps registered in the exclusion app list at the time of transition to the hibernation state, and instructs the app management unit 31 to terminate the apps registered in the restart app list and the force-close app list. Therefore, the smart device 1b can prevent missing part from the screen at the time of resuming from the hibernation state.

### [d] Fourth Embodiment

In the third embodiment, the case in which the exclusion app list is created by the user has been explained; however, the exclusion app list may be created automatically. Therefore, a smart device that automatically creates the exclusion app list will be explained in a fourth embodiment.

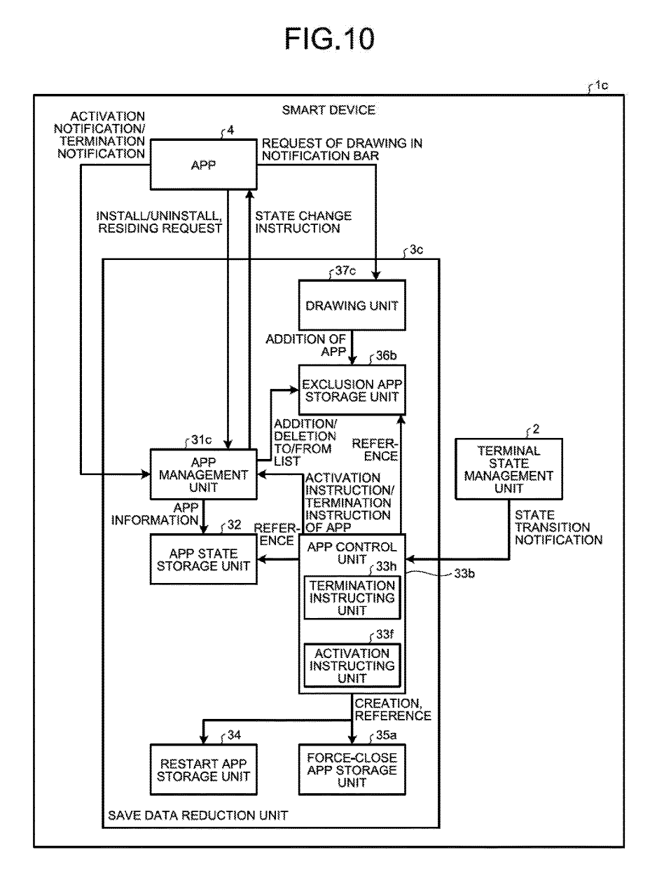

FIG. 10 is a diagram illustrating a functional configuration of a smart device according to the fourth embodiment. Herein, for the sake of simplicity of explanation, the same reference signs are assigned to function units that play the same roles as the units illustrated in FIG. 7, and detailed description thereof is omitted.

As illustrated in FIG. 10, a smart device 1c includes a save data reduction unit 3c instead of the save data reduction unit 3b as compared with the smart device 1b illustrated in FIG. 7. The save data reduction unit 3c includes an app management unit 31c instead of the app management unit 31 and includes a new drawing unit 37c as compared with the save data reduction unit 3b illustrated in FIG. 7.

The drawing unit 37c receives a request from the app 4 and performs processing of drawing a screen. When receiving a request of drawing in the notification bar 5, the drawing unit 37c adds the app 4 that requests the drawing to the exclusion app list.

When the app 4 that displays the home screen or the app launcher is installed in addition to the function provided in the app management unit 31, the app management unit 31c adds the App name to the exclusion app list, and deletes, when an app is uninstalled, the name of the app from the exclusion app list.

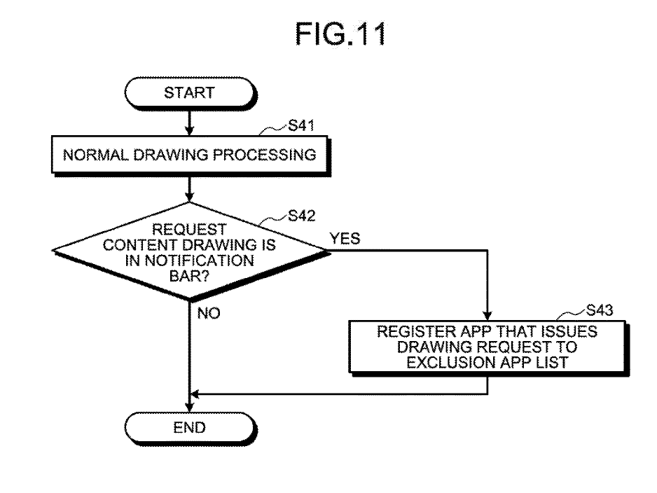

A flow of processing performed by the drawing unit 37c will be explained next. FIG. 11 is a flowchart illustrating a flow of processing performed by the drawing unit 37c. As illustrated in FIG. 11, when drawing is requested from the app 4, the drawing unit 37c performs normal drawing processing (Step S41).

The drawing unit 37c then determines whether the request content is the drawing in the notification bar 5 (Step S42), and registers, when it is the drawing in the notification bar 5, the app 4 that issues the drawing request in the exclusion app list (Step S43).

Thus, the drawing unit 37c registers the app 4 that performs drawing in the notification bar 5 in the exclusion app list, and the smart device 1c can thereby automatically create the exclusion app list.

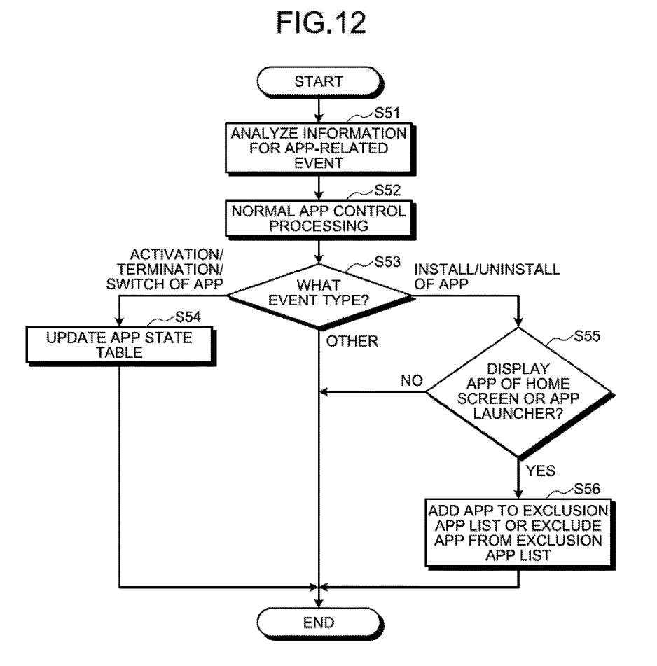

A flow of processing performed by the app management unit 31c will be explained next. FIG. 12 is a flowchart illustrating a flow of processing performed by the app management unit 31c. As illustrated in FIG. 12, the app management unit 31c analyzes information for an app-related event (Step S51). The app management unit 31c performs the normal app control processing according to the type of the event (Step S52).

The app management unit 31c determines what an event type is (Step S53). As a result, when the event type is activation, termination, or switch of the app 4 received from any device other than the app control unit 33b, the app management unit 31c updates the app state table (Step S54).

When the event type is install or uninstall of an app, the app management unit 31c determines whether the type of the app 4 is a display app of the home screen or the app launcher (Step S55). As a result, when the type of the app 4 is a display app of the home screen or the app launcher, the app management unit 31c adds or deletes the display app of the home screen or the app launcher to or from the exclusion app list (Step S56).

Thus, the app management unit 31c adds the display app of the home screen or the app launcher to the exclusion app list, and the smart device 1c can thereby automatically create the exclusion app list.

As explained above, in the fourth embodiment, the drawing unit 37c adds the app 4 that performs drawing in the notification bar 5 to the exclusion app list, and the app management unit 31c adds the display app of the home screen or the app launcher to the exclusion app list. Therefore, the smart device 1c can automatically create the exclusion app list.

### [e] Fifth Embodiment

In the first to the fourth embodiments, the case of recognizing the resident app based on the residing request received from the app 4 has been explained; however, it is possible to understand the resident app by analyzing package information of the app 4. Therefore, in a fifth embodiment, a smart device that understands the resident app by analyzing the package of the app 4 will be explained below.

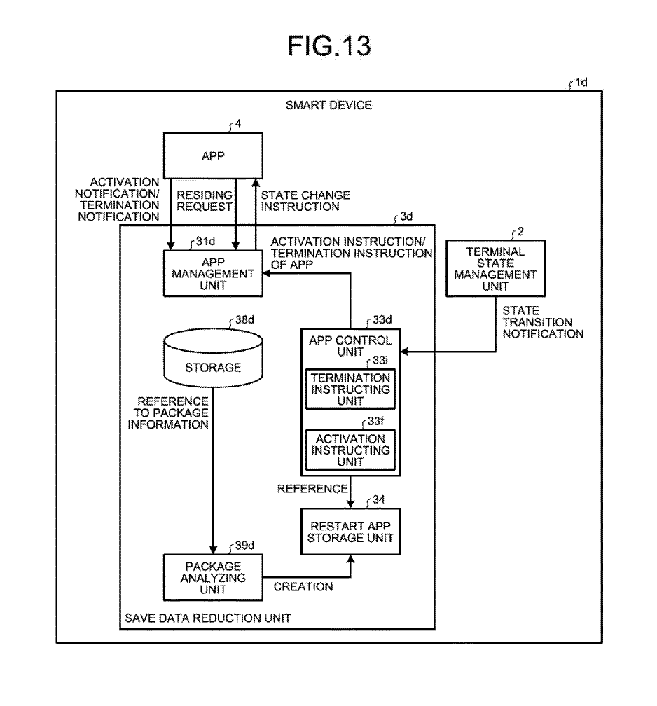

FIG. 13 is a diagram illustrating a functional configuration of a smart device according to the fifth embodiment. For the sake of simplicity of explanation, the same reference signs are assigned to function units that play the same roles as the units illustrated in FIG. 1, and detailed description thereof is omitted.

As illustrated in FIG. 13, a smart device 1d includes a save data reduction unit 3d instead of the save data reduction unit 3 as compared with the smart device 1 illustrated in FIG. 1. The save data reduction unit 3d includes an app management unit 31d instead of the app management unit 31 and includes an app control unit 33d instead of the app control unit 33, as compared with the save data reduction unit 3 illustrated in FIG. 1. The save data reduction unit 3d does not include the app state storage unit 32 but newly includes a storage 38d and a package analyzing unit 39d.

The storage 38d stores package information of the app 4. The package information includes a permission list (e.g., manifest.html) indicating various operations performed by the app 4 and a configuration of programs for the purpose of security. When the app 4 is the resident app, there is a definition that indicates the resident app in the permission list (e.g., <service android: name=“resident App name”></service>). When the app 4 is the resident app, the resident app may be enclosed in the package.

The package analyzing unit 39d refers to the package information stored in the storage 38d to create a restart app list. The app control unit 33d includes a termination instructing unit 33i instead of the termination instructing unit 33e as compared with the app control unit 33 illustrated in FIG. 1. The termination instructing unit 33i has the same function as that of the termination instructing unit 33e illustrated in FIG. 1, but does not create the restart app list. The app management unit 31d has the same function as that of the app management unit 31 illustrated in FIG. 1, but does not update the app state table.

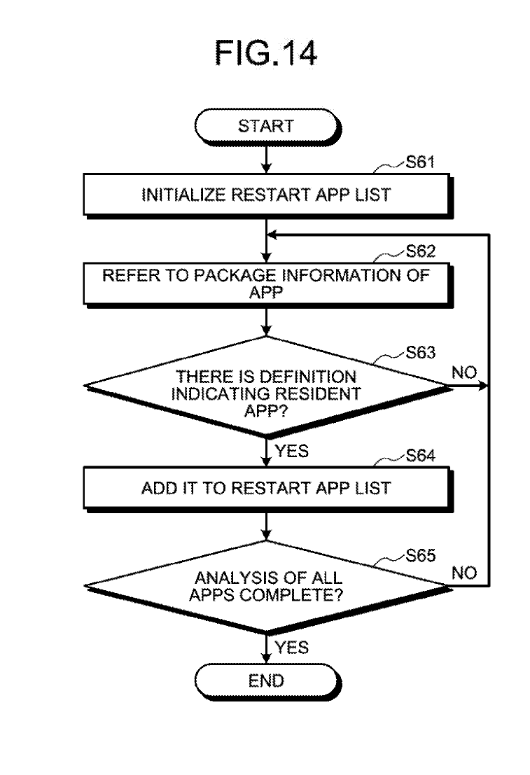

A flow of processing performed by the package analyzing unit 39d will be explained next. FIG. 14 is a flowchart illustrating a flow of processing performed by the package analyzing unit 39d. As illustrated in FIG. 14, the package analyzing unit 39d initializes the restart app list (Step S61).

The package analyzing unit 39d refers to the package information of the app 4 (Step S62), to determine whether there is a definition of residence (Step S63). As a result, when there is no definition of residence, the package analyzing unit 39d returns to Step S62, and adds the App name to the restart app list when there is a definition of residence (Step S64).

The package analyzing unit 39d determines whether analysis of all the apps has been completed (Step S65), ends the processing when the analysis of all the apps has been completed, and returns to Step S62 when there is any app 4 whose analysis has not been completed.

Thus, the package analyzing unit 39d creates the restart app list, and the smart device ld can thereby terminate the resident app at the time of transition to the hibernation state.

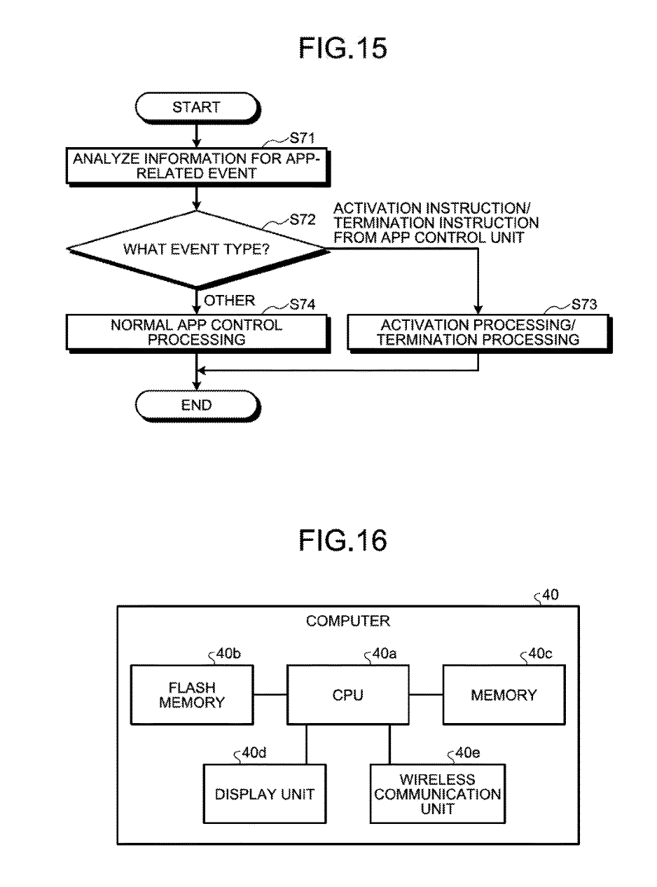

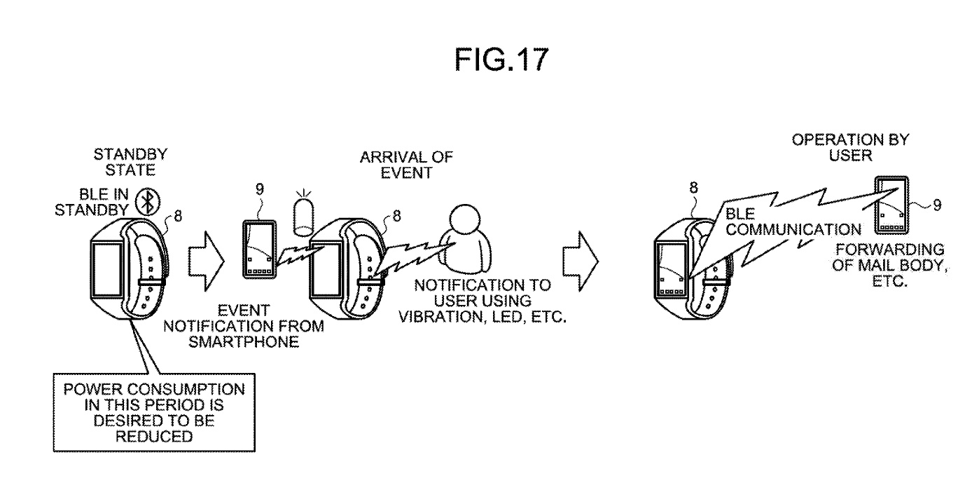

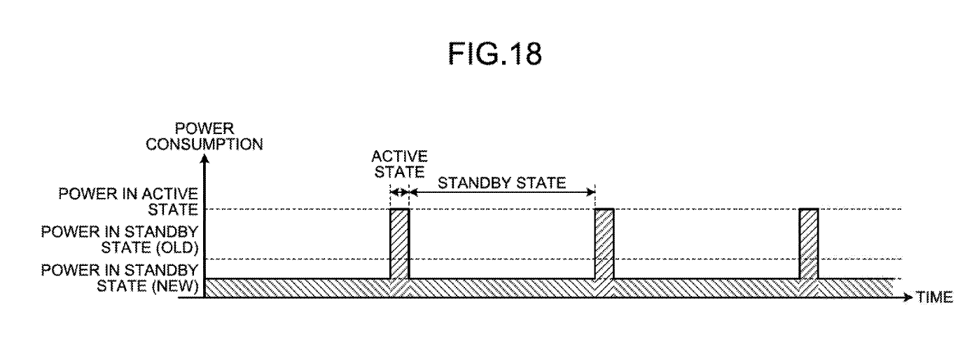

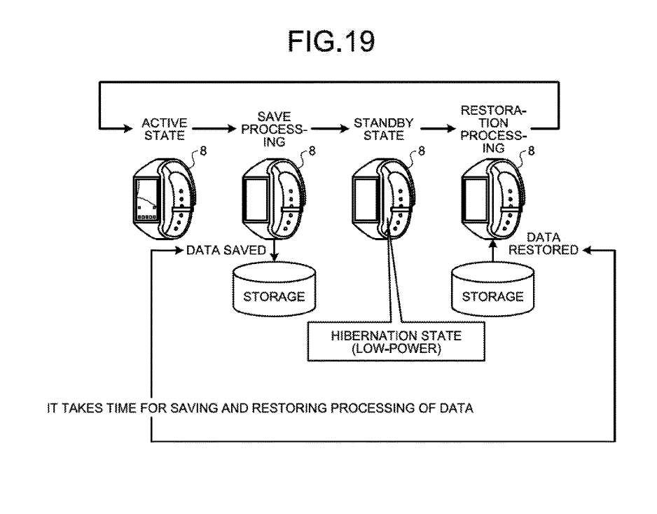

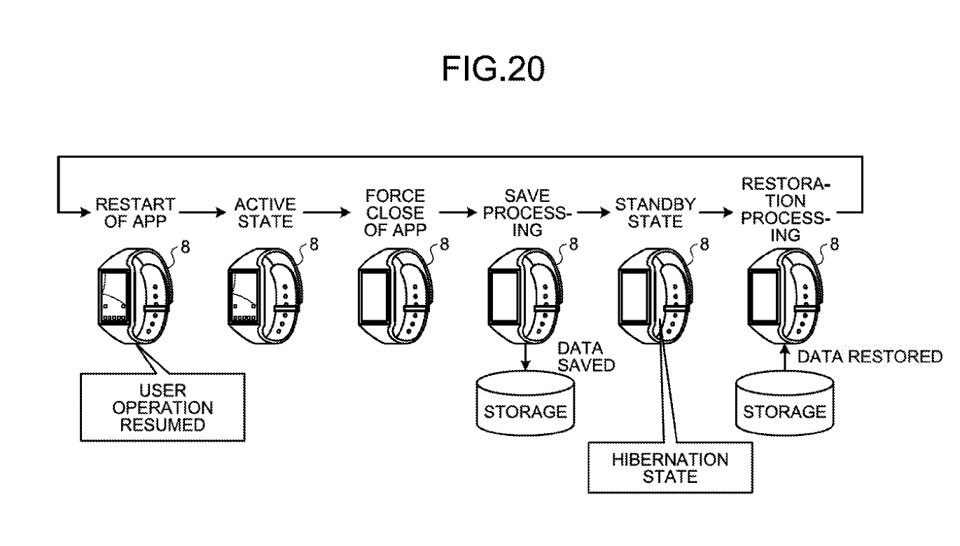

A flow of processing performed by the app management unit 31d will be explained next. FIG. 15 is a flowchart illustrating a flow of processing performed by the app management unit 31d. As illustrated in FIG. 15, the app management unit 31d analyzes information for an app-related event (Step S71).

The app management unit 31d then determines what an event type is (Step S72). As a result, when the event type is an activation instruction or a termination instruction of the app 4 received from the app control unit 33d, the app management unit 31d performs the activation processing or the termination processing of the app 4 (Step S73). When the event type is any other than the processing, the app management unit 31d performs the processing corresponding to the event type, that is, performs the normal app control processing (Step S74).

Thus, because the package analyzing unit 39d creates the restart app list, the app management unit 31d can omit the processing of creating the restart app list.

As explained above, in the fifth embodiment, the package analyzing unit 39d refers to the package information stored in the storage 38d to create the restart app list. Therefore, the smart device ld can terminate the resident app at the time of transition to the hibernation state.

The save data reduction units illustrated in the first to the fifth embodiments are implemented by a computer executing the save data reduction programs having the same functions. Therefore, the computer that executes the save data reduction programs will be explained below.

FIG. 16 is a diagram illustrating a hardware configuration of the computer executing the save data reduction programs according to the first to the fifth embodiments. As illustrated in FIG. 16, a computer 40 includes a CPU 40a, a flash memory 40b, a memory 40c, a display unit 40d, and a wireless communication unit 40e.

The CPU 40a is a processor that reads and executes a program such as the app 4 and the save data reduction program stored in the memory 40c. The flash memory 40b is a nonvolatile memory that stores the apps, the save data reduction programs, the package information, and the like. The flash memory 40b corresponds to the storage 38d illustrated in FIG. 13.

The memory 40c is a random access memory (RAM) that stores the app 4 and the save data reduction program, etc., read from the flash memory 40b. The memory 40c stores data needed for execution of the save data reduction program, an intermediate result of execution of the save data reduction program, and the like.

The display unit 40d is a device that displays a screen output by the app 4, for example, a liquid crystal display device. The notification bar 5 is displayed on the display unit 40d. The display unit 40d receives a touch operation of the user and transmits the received data to the CPU 40a.

The wireless communication unit 40e is a module that performs wireless communication such as wireless local area network (wireless LAN), Bluetooth, and communication for mobile phone. The wireless communication unit 40e may include a plurality of wireless communication functions.

According to one aspect of the present application, it is possible to reduce an amount of data to be saved during hibernation.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A device comprising:
a memory configured to store save data that is used to execute an application on the device; and
a processor coupled to the memory and the processor configured to:
instruct termination of a resident application which is a periodically executed application when the device is to be transited to a hibernation state which indicates a standby state with storing the save data in the memory; and
activate the resident application of which termination is instructed when resuming the device from the hibernation state.

2. The device according to claim 1, wherein the processor is further configured to:
change an application of which residing request is received to a resident application; and
instruct termination of the changed resident application.

3. The device according to claim 1, wherein the processor is further configured to:
analyze package information of an application;
determine whether the application is a resident application; and
instruct termination of the application determined as the analyzed resident application.

4. The device according to claim 1, wherein the processor is further configured to:
instruct termination of a resident application excluding a resident application that performs a display on a notification bar.

5. The device according to claim 4, wherein the processor is further configured to:
specify the resident application that performs a display on the notification bar; and
instruct termination of a resident application excluding the specified resident application as one that performs the display on the notification bar.

6. The device according to claim 1, wherein the processor is further configured to:
instruct termination of a background application excluding an application that displays a home screen and an application launcher.

7. A save data reduction method executed by a computer, the save data reduction method comprising:
instructing, using a processor, termination of a resident application which is a periodically executed application when the device is to be transited to a hibernation state which indicates a standby state with storing the save data in a memory; and
activating, using the processor, the resident application of which termination is instructed at the time of transition to the hibernation state, when resuming from the hibernation state.

8. A non-transitory computer-readable recording medium that stores therein a save data reduction program that causes a computer to execute a process comprising:
instructing termination of a resident application which is a periodically executed application when the device is to be transited to a hibernation state which indicates a standby state with storing the save data in a memory; and
activating the resident application of which termination is instructed at the time of transition to the hibernation state, when resuming from the hibernation state.
